(19) United States
(12) Patent Application Publication
(10) Pub. No.: US 2007/0193106 A1
(43) Pub. Date: Aug. 23, 2007

(54) Device for fishing

(75) Inventor: Timothy M. Gregory, Alpharetta, GA (US)

Correspondence Address: SMITH FROHWEIN TEMPEL GREENLEE BLAHA, LLC, Two Ravinia Drive, Suite 700, ATLANTA, GA, 30346, US

(73) Assignee: Timothy M. Gregory, Alpharetta, GA (US)

(21) Appl. No.: 11/529,460

(22) Filed: Sep. 27, 2006

Related U.S. Application Data
(60) Provisional application No. 60/776,082, filed on Feb. 23, 2006.

(51) Int. Cl. A01K 85/00

(52) U.S. Cl. 43/42.36; 43/42.39

(57) ABSTRACT

A device for fishing that includes a weight having an opening through which a fishing line can be threaded and a helical coil that defines an interior bore attached to the weight such that the opening in the weight and the interior bore of the helical coil align axially so that a fishing line can be threaded through the weight and the helical coil is provided. The device can be used to provide weight to a soft artificial lure, such as a plastic worm, in an arrangement referred to as a Texas rig.

### CROSS-REFERENCE TO RELATED APPLICATIONS

This application claims the benefit of U.S. Provisional Application No. 60/776,082 entitled “Device for Fishing” and filed on Feb. 23, 2006 the entire contents of which is hereby incorporated by reference and made a part hereof.

### BACKGROUND OF THE INVENTION

Fisherman and marketers are always looking for better ways to catch fish. Examples of devices that have been developed to improve the fishing experience include: Texas rigs and Carolina rigs; a noise-making weight device of U.S. Pat. No. 5,381,622; a jigging system of U.S. Pat. No. 5,535,540; a hook device of U.S. Pat. No. 5,784,827; a spinner bait of U.S. Pat. No. 6,266,914; and a hook device of U.S. Pat. No. 6,240,672.

Conventional “Texas” rigged fishing lures are known and are used by recreational, sport and professional bass fisherman. Versions of Texas rigs are described and illustrated in U.S. Pat. Nos. 5,025,586; 5,129,175; 5,490,345; and 6,161,326. Generally, Texas rigs employ a sinker or weight and a hook that are attached to a line with the hook embedded in a soft plastic lure plastic, such as a plastic worm, so that the eyelet of the hook is located toward the head of the lure and the point of the hook is located toward the tail of the lure. Texas rigs may employ either a slip or a fixed sinker on the fishing line in front of the artificial lure. Frequently, the sinker is made of lead and is bullet shaped. Such sinkers are referred to as bullet sinkers. The sinker is used to assist in casting the lure and also assists the lure toward the bottom where it can be fished.

As previously stated, the sinker may be fixed or may be allowed to slide freely on the main fishing line. A “slip” sinker may provide increased feel but can slide far up the line away from the bait and can cause inaccurate casts and poor presentation of the bait. Texas rigged sinkers that are fixed relatively securely against the nose of a soft bait act as a single unit that can be slipped through weeds and resist snagging in weeds and other obstacles that the rig may encounter. Thus, Texas rigs with fixed sinkers can be fished in heavier cover. Accordingly, Texas rigs with sinkers that can be fixed in relation to the bait are desirable.

Devices have been developed to make easier or otherwise improve the use and performance of Texas rigged lures and to fix insert the position of the sinker in relation to the bait. One class of such devices are illustrated and described in U.S. Pat. Nos. 5,025,586 and 5,129,175. The devices illustrated and described in U.S. Pat. Nos. 5,025,586 and 5,129,175 require a helical coil spring attached to a bullet-shaped sinker and a plastic tubular insert extending axially through both the helical coil spring and the sinker. The spring is provided to allow the sinker to be screwed into the head of a soft plastic worm and the tubular insert is ostensibly provided to limit fraying of the fishing line. However, the tubular insert often impedes setting of the fishing hook by limiting movement of the eye of the hook and, thus, the hook. Specifically, the tubular insert is composed of a relatively rigid material that tends to restrict movement of the eyelet portion of the hook through the head of the lure.

U.S. Pat. No. 5,490,345 illustrates and describes another sinker apparatus for use with a Texas rigged fishing lure. The device illustrated and described in U.S. Pat No. 5,490,345 includes a non-resilient plastic screw element, a bullet-shaped sinker and a plastic tubular insert extending axially through both the plastic screw element and the sinker. The plastic screw element is provided to allow the sinker weight to be screwed into the head of the plastic worm. The non-resilient plastic screw element and the tubular insert impede setting of the fishing hook by limiting movement of the eye of the hook and, thus, the hook.

Generally, these prior art devices hinder proper setting of the hook and also limit the placement as well as the type of fishing hook that can be used that can be used with such devices. For example, when a fisherman pulls on the line to set a hook into a fish, the point of the hook will be unable to pierce fully through the worm or other soft artificial bait and set in the fish. Moreover, the sinker portion of the devices does not reliably dislodge or release from the worm after a fish strike. The coil spring or plastic of the devices is wound a considerable distance into the worm. As a result, the sinker tends to remain lodged in the worm even after the fish strikes. This may cause the line to which the sinker is attached to break as the fish is reeled in by the fisherman. In addition, because the sinker is effectively fixed, it does not provide nearly as satisfactory a feel as is provided by more free moving sinkers.

It would be desirable to provide a weighted device for Texas rigging soft artificial lures that may requires fewer parts, that may be easier to manufacture and/or assemble and that may be more economically manufactured.

Thus, there is still a need for improved weighted devices for Texas rigging fish baits.

### BRIEF SUMMARY OF THE INVENTION

In one desirable embodiment, the present invention provides a device for fishing that includes, among other elements, a weight formed from tungsten or an alloy of tungsten and a helical coil formed from nickel, titanium, an alloy of titanium or nickel and combinations thereof wherein the helical coil defines an interior bore and is attached to the weight such that an opening in the weight and the interior bore of the helical coil align axially so that a fishing line can be threaded through the weight and helical coil and tied to a hook which may then be inserted in a soft artificial lure.

In other desirable embodiments, the present invention provides a device for fishing that consists of or consisting essentially of metal and includes a weight having an opening through which a fishing line can be threaded and a helical coil that defines an interior bore where the helical coil is attached to the weight such that the opening in the weight and the interior bore of the helical coil align axially so that a fishing line can be threaded through the weight and the helical coil. In certain desirable embodiments, the helical coil is formed from titanium, an alloy of titanium, nickel or an alloy of nickel. In certain desirable embodiments, the helical coil is formed from an alloy that includes titanium and nickel. In one group of particularly desirable embodiments, the helical coil is formed from an alloy that comprises at least about 40 weight percent of titanium. In other embodiments, the helical coil is formed from an alloy that comprises at least about 40 weight percent of titanium and at least about 50 weight percent of nickel. In still other embodiments, the helical coil is formed from an alloy that comprises from about 50 to about 60 weight percent of nickel, more particularly from about 53 to about 58 weight percent of nickel and still more particularly from about 55 to about 56 weight percent of nickel with the majority of the remaining weight of the alloy being titanium. Desirably, such alloys are superelastic and maintain their superelastic properties within the temperature range of from about 30° F. to about 130° F.

In certain embodiments, the weight is formed from tungsten or an alloy of tungsten. And in particularly desirable embodiments, the weight is formed from tungsten or an alloy of tungsten and the helical coil is formed from titanium, an alloy of titanium, nickel or an alloy of nickel. Thus, in one desirable embodiment, the weight is formed from tungsten or an alloy of tungsten and the helical coil is formed from an alloy that comprises from about 55 to about 85 weight percent of titanium and from about 15 to about 45 weight percent of nickel. In certain embodiments, the helical coil has a length that is less than about three quarters of the length of the weight. And in other embodiments, the helical coil has a length that is not greater than about two thirds of the length of the weight portion of the device.

### BRIEF DESCRIPTION OF THE DRAWINGS

Having thus described the invention in general terms, reference will now be made to the accompanying drawings, which are not necessarily drawn to scale, and wherein:

FIG. 1 depicts a perspective view of a device according to the present invention illustrating the sequential rigging of a worm in a Texas rig arrangement.

FIG. 1A depicts an enlarged, perspective view of a device according to one embodiment of the invention with a fishing line threaded through the device.

FIG. 2 depicts a perspective view of the device of FIG. 1A in use in a Texas rig arrangement.

FIG. 3 depicts an enlarged, cross-sectional view of the device of FIG. 1A in use in a Texas rig arrangement.

FIG. 4 depicts an enlarged, cross-sectional view of a device of another embodiment of the invention in use in a Texas rig arrangement.

FIG. 5 depicts an enlarged, cross-sectional view of a device of yet another embodiment of the invention in use in a Texas rig arrangement.

FIG. 6 depicts an enlarged, cross-sectional view of the device of FIG. 1A in use in a Texas rig arrangement in a relaxed state ready to be fished.

FIG. 6A depicts an enlarged, cross-sectional view of the device of FIG. 1A in use in a Texas rig arrangement in an ideal compressed state during hook setting.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

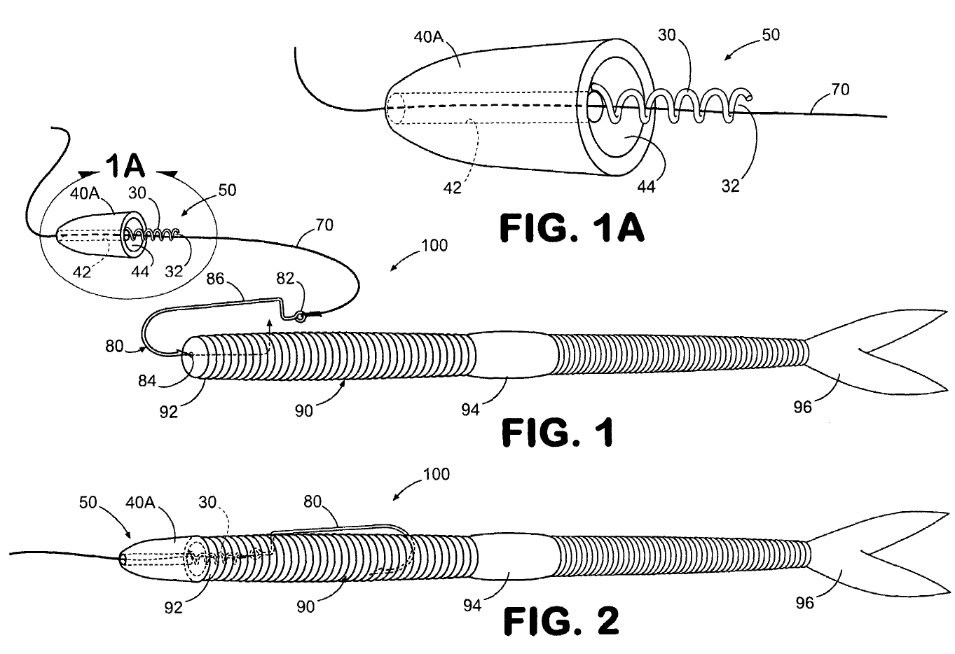

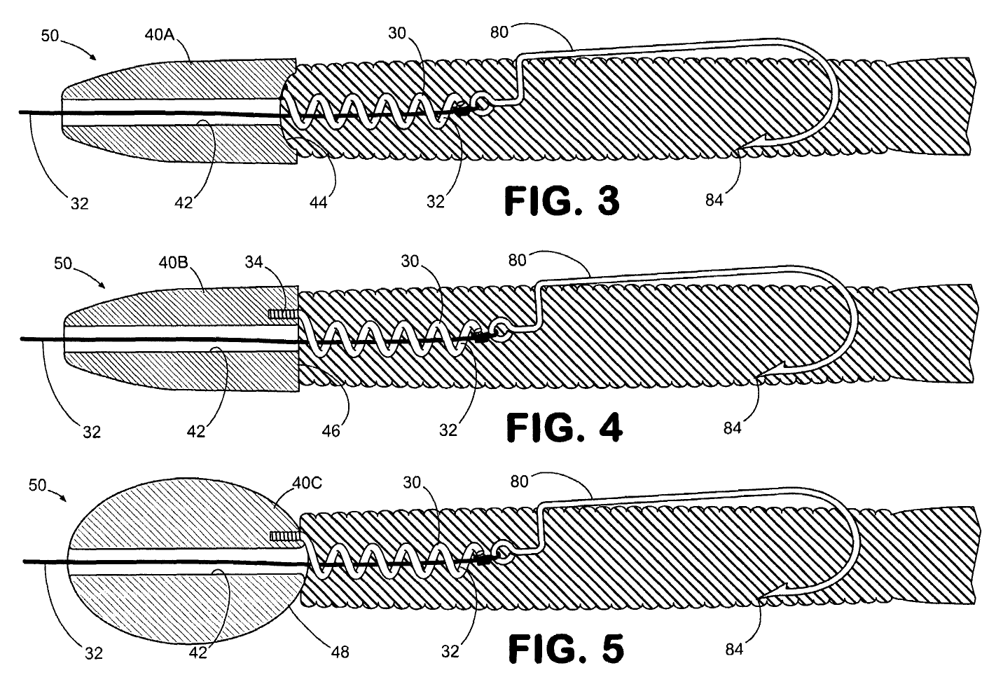

A first embodiment of a device of the present invention is illustrated in FIGS. 1 and 1A. The device 50 includes a weight 40A having an opening 42 extending axially through the long axis of the weight and a helical coil 30 that defines an interior bore 32 attached to the weight with the opening 42 in the weight and the interior bore 32 of the helical coil aligning axially so that a fishing line 70 can be threaded through the device 50 consisting of the weight 40A and the helical coil 30. The device of the embodiment illustrated in an enlarged view in FIG. 1A is also depicted in perspective view in FIG. 1 to illustrate the sequential rigging of a worm 90 in a Texas rig 100. FIG. 2 depicts a completed Texas rig arrangement using a worm 90. FIG.3 depicts an enlarged, partial cross-sectional view of FIG.2. The Texas rig arrangements illustrated in FIGS. 2-6 are considered “weedless” arrangements because the point of the hook does not protrude from the artificial bait during normal retrieval. Devices of the present invention may be fished in non-weedless configurations as well as other arrangements if desired.

The weight 40 may be formed from lead, tin, antimony, tungsten, an alloy of any of the previously listed metals, plastic or any other material that can be used to form a sinker. In certain desirable embodiments, the weight 40 is formed from tungsten or an alloy of tungsten. It is believed that tungsten weights provide improved sensitivity compared to conventional weights. Furthermore, the tungsten weight and the devices of the present invention do not include or require a plastic sleeve to reduce fraying. Plastic inserts can dull feel and further compromise sensitivity. The mass of the device 50 and the weight 40 or the weighted portion of the device may vary. Suggested weights include, but are not limited to, 1/16, ⅛, 3/16, ¼, 5/16, ⅜, ½, and ¾ of an ounce. However, it should be noted that the mass of the device 50 and of the weight 40 may vary greatly as needed and may weigh one ounce or more. The shape of the weight 40 may also vary, for example as illustrated in FIGS. 3, 4 and 5. Suggested shapes for the weight 40 include, but are not limited to, bullet shapes as illustrated in cross section in FIGS. 3 and 4 and egg shapes as illustrated in cross section in FIG. 5. Other shapes for fishing weights that are known may be used for the weight portion of the devices of the present invention. The bullet-shaped weight 40A may have a concave rear surface 44 for fitting the curved nose of a worm as illustrated in FIG. 3 or the bullet-shaped weight 40B can have a flat rear surface 46 as illustrated in FIG. 4.

In preferred embodiments, the weight portion (40A, 40B or 40C referred to generally as 40) of the devices of the present invention are made of a tungsten alloy and do not require an insert to limit fraying of a fishing line 70 that is threaded through an opening 42 provided in the weight 40. In one exemplary embodiment, weight 40A is made from tungsten, more specifically an alloy of tungsten that contains at least about 97 percent by weight of tungsten. Advantageously, tungsten sinkers are smaller and harder than lead sinkers. More advantageously, tungsten sinkers do not contain lead and are more environmentally friendly than conventional sinkers. The weighted portion of the devices of the present invention, for example the weight 40A, may also include a color coating or may be otherwise colored or painted to provide fishermen with a choice of colors that may contrast with, complement or otherwise match the color of an artificial lure that will be combined with the device. Examples of colors that are frequently used for artificial lures include, but are not limited to, shades of black, red, blue, green, purple and so forth. The weight 40 may also include optional noise making features as are known in the art. One example of which is described and illustrated in U.S. Pat. No. 5,381,622.

The helical coil 30 portion of the device 50 is desirably a metal spring formed a shape memory alloy, for example from titanium, an alloy of titanium, nickel, an alloy of nickel or an alloy of nickel and titanium. The alloys may include other elements. Examples of other metals that may be included in the nickel and titanium alloy include, but are not limited to, copper, iron, chromium, vanadium hafnium and palladium. In one group of particularly desirable embodiments, the helical coil is formed from an alloy that comprises at least about 40 weight percent of titanium. In other embodiments, the helical coil is formed from an alloy that comprises at least about 40 weight percent of titanium and at least about 50 weight percent of nickel. In still other embodiments, the helical coil is formed from an alloy that comprises from about 50 to about 60 weight percent of nickel, more particularly from about 53 to about 58 weight percent of nickel and still more particularly from about 55 to about 56 weight percent of nickel with the majority of the remaining weight of the alloy being titanium. Desirably, such alloys are superelastic and maintain their superelastic properties within the temperature range of from about 30° F. to about 130° F.

One commercially available version of such a superelastic alloy is NiTinol shape memory alloy. NiTinol alloy is considered particularly advantageous because of its superior properties, such as, shape memory, corrosion resistance, resistance to cyclical fatigue, and flexibility compared to stainless steel and most other metals that are typically used for springs and other fishing lure components. Advantageously, NiTinol and other superelastic alloys possess superelastic properties that allow the ally to return to its original shape after being deformed substantially. This property has made the NiTinol alloy popular for use in orthodontics, stents and other medical devices. Another example of an alloy of titanium is “beta” titanium which is an alloy of at least 40 weight percent of titanium and other metals that may include, but are not limited to, manganese, iron, chromium, cobalt, nickel, copper, tin and zirconium. Importantly, it is believed by the inventors that superelastic alloy springs and coils, and in particular, nickel/titanium alloy springs and coils, reduce and may even eliminate fraying of a fishing line. Other superelastic alloys may be used to form the helical coil and may include alloys, but are not limited to, alloys of titanium and copper, chromium, and/or iron. Such alloys are also referred to as smart materials.

The helical coil 30 defines an interior bore 32 though which a fishing line 70 can be threaded as illustrated in a manner similar to the way a ball point pen refill is fit into a spring. The helical coil 30 is attached to the weight 40 so that the opening 42 in the weight and the interior bore 32 of the helical coil align axially. Thus, a fishing line 70 can be threaded through both the weight 40 and the interior bore 32 of the helical coil with ease. The helical coil 30 can be attached to the weight 40 by threading the coil or a portion of the coil into a recess that may be provided in the weight, by welding, by the use of an adhesive or by any other method, device or process that can be used to join two metal parts together. The combination of the weight 40 and the helical coil 30 without an insert allows the helical coil 30 to be compressed, deflected or otherwise moved by a hook. More specifically, devices of the present invention allow the eye of a hook to compress or deflect the helical coil 30 during setting of the hook when a fisherman reacts to a bite, thus, allowing the hook to penetrate and come out of the side of the worm greatly improving the probability and the quality of hook set. The prior art devices do not allow compression or deflection of the helical coil or spring and limit placement and movement of a hook within a worm or other artificial bait during fishing of the artificial bait.

The length of the helical coil 30 of the device 50 may vary and is desirably shorter than the length of the weight portion 40 of the device 50. In one exemplary embodiment, the device consists of a one quarter of ounce tungsten bullet-shaped sinker that is about 11 millimeters in length and about 6 millimeters in diameter at the rear of the bullet sinker that is adhered to a titanium and nickel alloy spring that is about 7 to about 8 millimeters in length and about 2 millimeters in diameter. Thus, in certain embodiments, the length of the spring is less than about three quarters of the length of the weight. In certain more desirable embodiments, the length of the spring is not greater than about two thirds of the length of the weight. In certain embodiments, the diameter of the spring is less than about 3 millimeters.

The arrangement and use of device 50 to form a Texas rigged worm arrangement illustrated generally as 100 will now be described with reference to FIGS. 1 and 2. The Texas rig assembly 100 includes a rubber or plastic worm 90 through which a fish hook 80 is embedded according to the known “Texas” rig technique. As shown in FIG. 1, hook 80 includes an eyelet 82 at one end, a barbed point 84 at the opposite end and an intermediate shaft 86 which also may be referred to as a shank. Fishing line 70 is threaded through device 50, more specifically fishing line 70 is threaded through opening 42 provided in the weight 40 and interior bore 32 of helical coil 30 as shown in greater detail in FIG. 1A, and then tied to or otherwise secured to hook 80 as shown in FIG. 2. Thus, weight 40 and device 50 are slidably mounted along line 70.

To completely assemble a Texas rig 100, point 84 of hook 80 is embedded into the head portion 92 of worm 90 as illustrated in FIG. 1. Point 84 of hook 80 is then manipulated through the body of worm 94 and extended out of the body and then inserted back into the body once again to the final position shown in FIG. 2. Desirably, point 84 is embedded in the body portion 94 of worm 90 so that the point 84 just penetrates or lies just below exterior surface of the worm toward the tail portion 96 of the worm as shown in FIG. 2. This configuration is believed to best protect the point 84 from entangling with underwater plants. In more clear and open water conditions, point 84 may be extended completely through the body of worm 90. In either event, eyelet portion 82 should remain embedded within the worm relatively toward head portion 92 of the soft artificial lure. After the hook has been secured to the worm in this manner, the device 50 is drawn along line 70 and the spring portion 30 of the device is screwed or otherwise inserted into head portion 92, as illustrated in FIGS. 2, 3, 4 and 5. The device 50 and accompanying Texas rig assembly 100 are now ready to be cast and fished.

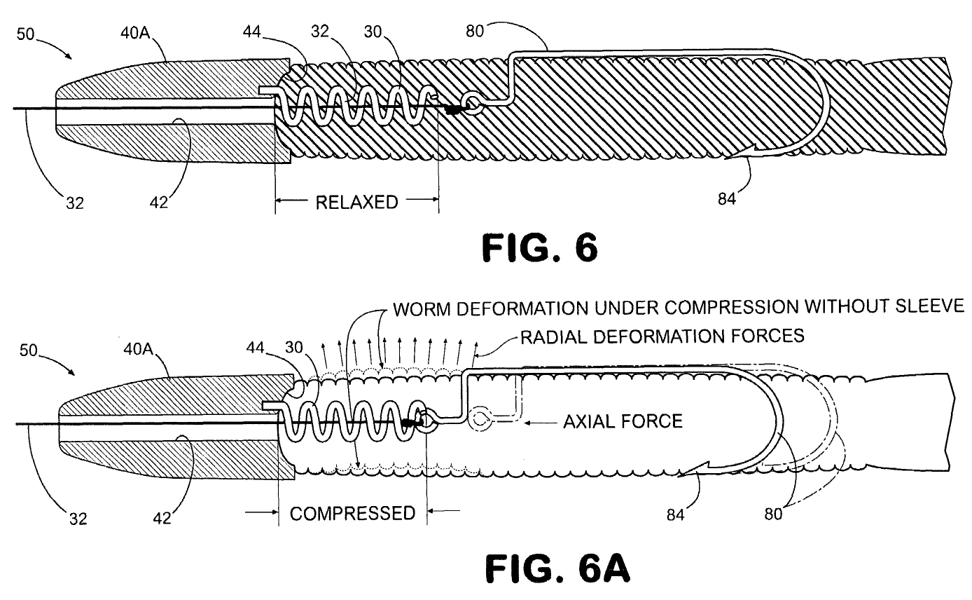

FIG. 6 depicts an enlarged, cross-sectional view of the device of FIG. 1A in use in a Texas rig arrangement in a relaxed state and ready to be fished. Desirably, the hook is positioned in the artificial bait so that there is a small gap between the eye of the hook and the end of the helical coil. The gap can provide slack and may improve hook setting. FIG. 6A depicts an enlarged, cross-sectional view of the device of FIG. 1A and FIG. 6 in use in a Texas rig arrangement in an ideal compressed state during hook setting. In such a desirable set up the hook moves forward during hook set allowing the point of the hook to penetrate through the outer surface of the artificial bait and into the intended target fish. Advantageously, the helical coil of the devices of the present invention may compress and improve opportunities for hook set in contrast to prior art devices that include a rigid sleeve that impedes compression and hook set.

Although a few devices of the present invention have been illustrated and described with respect to a plastic worm, devices of the present invention can be used with various types of baits, including artificial and natural baits. Generally, devices of the present invention are used in conjunction with soft artificial baits, including, but not limited to, grubs, lizards, jerk baits, minnows, crawfish, frogs, tubes, trailers and other artificial baits made from a soft plastic or rubber material. More importantly, the devices of the present invention can be used with hooks of various types, shapes, designs and sizes in addition to the hook illustrated in the Figures. Examples of types hooks that may be used with one of the devices of the present invention includes, but are not limited to, worm hooks, offset worm hooks, G-lock worm hooks round bend hooks, offset round bend hooks, O'Shaughnessy hooks, offset O'Shaughnessy hooks Aberdeen hooks, weedless hooks, baitholder hooks, jig hooks, sproat hooks, octopus hooks, straight shank round bend hooks, offset straight shank round bend hooks and so forth.

In addition to allowing for the use of a variety of types, shapes, designs and sizes of hooks, devices of the present invention permit pegging of the weight to the line to stabilize the position of the weight relative to the lure. Pegging of line can be achieved with a toothpick, a plastic wedge, a wedge made of other synthetic materials and by the use of other devices that have been used be fisherman to “peg” a weight. The prior art devices that included a spring attached to a weight also required a sleeve and the sleeve only provided enough room for a fishing line. These prior art devices do not facilitate pegging of the weight. Pinching and ultimately failure of a fishing line is likely when pegging is attempted with these prior art devices.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

What we claim is:

1. A device for fishing, the device for fishing consisting essentially of metal and comprising a weight having an opening through which a fishing line can be threaded and a helical coil that defines an interior bore, wherein the helical coil is attached to the weight such that the opening in the weight and the interior bore of the helical coil align axially so that a fishing line can be threaded through the weight and the helical coil.

2. The device of claim 1 wherein the helical coil is formed from titanium or an alloy of titanium.

3. The device of claim 1 wherein the helical coil is formed from nickel or an alloy of nickel.

4. The device of claim 1 wherein the helical coil is formed from a superelastic alloy.

5. The device of claim 1 wherein the helical coil is formed from an alloy that comprises from about 40 to about 50 weight percent of titanium, from about 50 to about 60 weight percent of nickel and from about 0 to about 10 weight percent of other elements.

6. The device of claim 1 wherein the weight is formed from tungsten or an alloy of tungsten.

7. The device of claim 1 wherein the helical coil is formed from titanium or an alloy of titanium and the weight is formed from tungsten or an alloy of tungsten.

8. The device of claim 1 wherein the helical coil is formed from nickel or an alloy of nickel and the weight is formed from tungsten or an alloy of tungsten.

9. The device of claim 1 wherein the helical coil is formed from an alloy of titanium and nickel and the weight is formed from tungsten or an alloy of tungsten.

10. The device of claim 1 wherein the helical coil is formed from an alloy that comprises from about 40 to about 50 weight percent of titanium and from about 50 to about 60 weight percent of nickel and the weight is formed from tungsten or an alloy of tungsten.

11. A device for fishing, the device for fishing consisting of a weight having an opening through which a fishing line can be threaded and a helical coil that defines an interior bore, wherein the helical coil is attached to the weight so that the opening in the weight and the interior bore of the helical coil align axially so that a fishing line can be threaded through the weight and helical coil.

12. The device of claim 11 wherein the helical coil is formed from titanium or an alloy of titanium.

13. The device of claim 11 wherein the helical coil is formed from nickel or an alloy of nickel.

14. The device of claim 11 wherein the helical coil is formed from an alloy that comprises titanium and nickel.

15. The device of claim 11 wherein the helical coil is formed from an alloy that comprises from about 55 to about 85 weight percent of titanium and from about 15 to about 45 weight percent of nickel.

16. The device of claim 11 wherein the helical coil is formed from nickel or an alloy of nickel and the weight is formed from tungsten or an alloy of tungsten.

17. The device of claim 11 wherein the helical coil is formed from an alloy that comprises from about 40 to about 50 weight percent of titanium, from about 50 to about 60 weight percent of nickel and the weight is formed from tungsten or an alloy of tungsten and from about 0 to about 10 weight percent of other elements.

18. A device for fishing comprising a weight formed from tungsten or an alloy of tungsten and having an opening through which a fishing line can be threaded and a helical coil formed from nickel, titanium or an alloy of titanium or nickel wherein the helical coil defines an interior bore and is attached to the weight such that the opening in the weight and the interior bore of the helical coil align axially so a fishing line can be threaded through the weight and the helical coil.

19. The device of claim 18 wherein the helical coil is formed from an alloy that comprises least about 40 weight percent of titanium.

20. The device of claim 18 wherein the helical coil is formed from an alloy that comprises least about 40 weight percent of titanium and at least about 50 weight percent of nickel.
